(19) United States
(12) Patent Application Publication
(10) Pub. No.: US 2008/0280153 A1
(43) Pub. Date: Nov. 13, 2008

(54) Method of Anodizing Aluminum Utilizing Stabilized Silicate Solutions

(76) Inventors: John Tony Kinard, Greer, SC (US); Brian John Melody, Greer, SC (US); Albert Kennedy Harrington, Fountain Inn, SC (US); David Alexander Wheeler, Williamston, SC (US)

Correspondence Address: NEXSEN PRUET, LLC, P.O. BOX 10648, GREENVILLE, SC, 29603, US

(21) Appl. No.: 12/175,525

(22) Filed: Jul. 18, 2008

Related U.S. Application Data
(62) Division of application No. 10/967,619, filed on Oct. 18, 2004.
Application No. 10/967,619 is a division of application No. 10/347,666, filed on Jan. 21, 2003, now abandoned.

(51) Int. Cl. B32B 15/20; C25D 11/06; H01G 9/045

(52) U.S. Cl. 428/472.2; 205/147; 361/529

(57) ABSTRACT

An anodizing solution, and method of anodizing, comprising suspending at least one aluminium substrate in an anodizing solution and applying an anodizing current to the anodizing solution. The anodizing solution comprises 0.01-5%, by weight, sodium silicate and 0.01-5%, by weight, α-amino acid.

### BACKGROUND OF THE INVENTION

The present invention relates to a method for anodizing aluminium and to a electrolyte solution therefore. More specifically, the present invention relates to a stabilized silicate solution and to an improved aluminium anodization process.

The process of anodizing metal surfaces is a widely practiced art. In general, the anodization process involves the electrolytic formation of a metal oxide at the surface of the metal in a controlled fashion to impart specific properties to the metal.

Aluminium has proven to be a particularly effective valve metal in solid electrolytic capacitors. Achieving optimum performance requires that a high quality anodic oxide film be produced on the capacitors anode foil. There has been an ongoing effort in the art to improve the characteristics of the oxide and thereby increase the performance of an aluminium electrolytic capacitor towards the theoretically achievable limit.

Boric acid and hydrated sodium tetraborate (borax) solutions have enjoyed much success for anodizing aluminium. More recently, improvements to this process have included the introduction of borate polyester solutions formed by the combination of boric acid and 2-methyl-1,3,propanediol at about 130 to 160° C. as exemplified in U.S. Pat. No. 6,346,185. Borates tend to precipitate in the etch tunnels of highly etched aluminium foils, such as are used in low-voltage capacitors, blocking off these tunnels and reducing the capacitance of the low voltage foils. Aluminium is somewhat soluble in borate solutions and therefore anodizing solutions based on simple borate salts must be replaced frequently due to increasingly high aluminium content.

Carboxylic acid salts, usually the ammonium salts, have largely replaced boric acid/borates as the ionogens in anodizing electrolytes for use in commercial production of anodized capacitor foil. Malic, tartartic and citric acid salts were among the first carboxylic acid salts used to anodize capacitor foil. As described in U.S. Pat. No. 4,715,936, carboxylic acid containing an alpha-hydroxy group (such as citric, malic and tartaric acids) tend to attack or dissolve any hydrated oxide produced during the anodizing, and while salts of these acids tend to produce highly hydration-resistant anodic aluminium oxide, the dissolution of the hydrated oxide results in low current efficiency and rapid solution loading with dissolved aluminium. The alpha-hydroxy carboxylic acid salts have been replaced by dicarboxylic acid salts, such as the ammonium salt of adipic acid. Aluminium tends to be very insoluble in dicarboxylic acid salt solutions and thus very high current efficiency is obtained during aluminium foil anodizing in dicarboxylic acid salt solutions.

However, there exists a major disadvantage with capacitor anode foil which has been anodized in a dicarboxylic acid salt solution, such as adipic acid salt solution. The anodic oxide produced in dicarboxylic acid salt solutions (such as adipate solution) is very susceptible to hydration degradation, i.e., the anodic oxide exhibits a strong tendency to react with moisture in its surroundings to yield a hydrated oxide having impaired insulating properties (high leakage current) and elevated dielectric losses (high dissipation factors). The hydration sensitivity of anodic aluminium oxide films produced in adipate or other dicarboxylate anion containing solutions, is sufficiently large that post-anodizing methods have been developed, such as those described in U.S. Pat. No. 4,481,084, which include heat-treating the anodic oxide to from 300° C. to 550° C. and re-anodizing, preferably in a phosphate-containing electrolyte.

A high-efficiency anodizing method, which produces a hydration-resistant anodic oxide film on aluminium, has been developed and described in U.S. Pat. No. 4,715,936. This method employs amino acids, preferably carboxylic amino acids having a 2-amino group (alpha amino group) as the ionogen in aqueous solution. Aqueous solutions of 2-amino dicarboxylic acids have been found to give rise to crystalline (hydration resistant) anodic aluminium oxide with minimal dissolution of the oxide and high resulting electrical efficiency.

The disadvantages of several of the anodizing methods and electrolytic solutions used by the capacitor foil industry may be magnified when these methods and materials are employed to anodize the edges of cut foil coupons welded to process bars and with masking material applied to them. Heat-treatment of the welded and masked coupons to from 400° C. to 550° C., as suggested in U.S. Pat. No. 4,481,084, is impractical due to decomposition of the masking material and warping of the process bars and fixtures supporting the coupons. Unfortunately, the use of a dicarboxylic acid salt anodizing solution (such as ammonium adipate solution) give rise to an anodic oxide which is highly susceptible to hydration. This problem is especially realized if a dicarboxylic acid salt solution was used to anodize the foil initially.

The use of aqueous (no organic co-solvent) phosphate solutions results in the deposition of solid phosphates on the bodies of coupons along the electrolyte/air interface unless very dilute (and difficult to control) solutions are employed. The more recently developed anodizing electrolyte solutions containing dicarboxylic amino acids, such as described in U.S. Pat. No. 4,715,936, produce anodic oxide on the edges of the aluminium coupons without airline corrosion nor solution control problems, but due to the non-aggressive nature of these materials to any hydrated oxide present (if, for example, the foil from which the anode coupons were cut was previously anodized in an ammonium adipate solution) coupon edge anodizing imparts little in the way of hydration resistance to anodic oxide already present in the coupons prior to the edge anodizing step.

Orthophosphate is a widely used as an anodizing solution. It has been known for years that orthophosphate anion strongly adsorbs on the surface of aluminium oxide. It has also been known that aqueous solutions of orthophosphate salts may be used, under certain circumstances, as anodizing electrolytes to anodize aluminium foil. It has been found that the pH of orthophosphate-based aqueous anodizing electrolytes for aluminium must be between about 5.0 and 7.0 for best results as indicated by lowest leakage current and highest capacitance value in finished capacitors.

As with most aluminium foil anodizing, aqueous phophate anodizing electrolytes are generally used at temperatures above 80° C. The rapid evaporation of the water fraction of the electrolyte at the point of contact between the anode foil and the electrolyte surface leads to concentration of the anionic species at the air-line contact region of the foil with the electrolyte. The acidic nature of the orthophosphate anion leads to so-called air-line corrosion of the aluminium foil during anodizing unless a low concentration of orthophosphate salt is used, generally below a concentration of 0.1%, and the foil has a hydrated surface. The hydrated surface coating has been found to be more resistant to attack by acidic orthophosphate than is uncoated aluminium. When these conditions of pH, phosphate concentration, and foil pre-hydration are met, the anodic oxide produced has been found to be particularly stable with respect to hydration attack in service in electrolytic capacitors containing liquid electrolyte having a water component.

Yet another problem with phosphate based anodization solutions is the detrimental formation of oxides between the phosphate and the aluminium surface. There has been a desire to eliminate the use of phosphates.

Silicates and tartrates are have also been described for use in aluminium anodization as exemplified in U.S. Pat. No. 4,204,919. Silicates are known to react with the surface of the aluminium. Due to the local gradient effects in the vicinity of the liquid/aluminium interface the pH decreases. The gradient caused by a lower pH causes high inconsistent doping of the surface since the silicates become increasing more insoluble as pH decreases. The inconsistent doping is manifest in unpredictable changes in the eventual capacitor. Sodium silicate is typically used at a pH of approximately 10.5 to reduce the occurrence of premature precipitation.

The skilled artisan has therefore been limited to the use of silicates, at a high pH wherein high uncontrollable silicate incorporation occurs, or at a low pH with dicarboxylic acids wherein an aluminium oxide surface can be obtained which is stable to hydrolysis. It has been a long felt desire in the art to achieve both properties yet this has not yet been realized.

### BRIEF SUMMARY OF THE INVENTION

It is object of the present invention to provide an improved process for anodizing aluminium.

It is another object of the present invention to provide an aluminium oxide surface on aluminium metal with low susceptibility to hydrolysis and low susceptibility to chemical decontamination.

It is another object of the present invention to provide an anodizing solution, particularly for use with aluminium, which can be maintained at an acidic pH and which is stable for extended periods of time without precipitation.

A particular feature of the present invention is the ability to form aluminium oxide on an aluminium metal with a sufficient level of silicate incorporated therein to decrease the chemical reactivity, particularly with respect to organic semiconductors production process reagents, and to decrease the detrimental effects of hydrolysis. These features are provided by utilization of a solution which is stable yet the stability of the solution does not compromise the reactivity desired.

These and other advantages, as would be realised to one of ordinary skill in the art, are provided in an electrolyte composition comprising about 0.01-5%, by weight, sodium silicate and about 0.01-5%, by weight, α-amino acid.

Another embodiment is provided in a method of anodizing comprising suspending at least one aluminium substrate in an electrolytic solution and applying an anodizing current to the electrolytic solution wherein the electrolyte solution comprises 0.01-5%, by weight, sodium silicate and 0.01-5%, by weight, α-amino acid.

Yet another embodiment is provided in a method for forming an aluminium oxide barrier layer on an aluminium substrate comprising suspending at least one aluminium substrate into an electrolytic solution and applying an anodizing current to the electrolytic solution wherein the electrolyte solution comprises 0.01-5%, by weight, sodium silicate and 0.01-5%, by weight, α-amino acid.

Yet another embodiment is provided in an aluminium substrate comprising an aluminium oxide barrier layer prepared by a method comprising suspending the aluminium substrate into an electrolytic solution and applying an anodizing current to the electrolytic solution wherein the electrolyte solution comprises 0.01-5%, by weight, sodium silicate and 0.01-5%, by weight, α-amino acid.

A particularly preferred embodiment is provided in an electrolyte composition comprising 0.1% and 1%, by weight, sodium silicate and 0.1% and 1%, by weight, at least one compound selected from a group consisting aspartic acid and glutamic acid wherein said electrolyte solution is at a pH of about 5 to about 7.

### DETAILED DESCRIPTION OF THE INVENTION

The inventors of the present application have developed, through diligent research, a stabilized sodium silicate solution which can be maintained at a neutral or acidic pH for extended period of time without degradation. In particular the present invention is directed to a sodium silicate solution which is stabilized with α-amino acids.

An anodizing solution of the present invention comprises sodium silicate and an α-amino acid. More preferably, the anodizing solution of the present invention comprises no more than about 5%, by weight, sodium silicate and no more than about 5%, by weight, α-amino acid. Above about 5%, by weight sodium silicate, or α-amino acid, the silicates begin to precipitate rapidly thereby rendering the solution useless for practical applications. It is most preferred that the amount of sodium silicate, and α-amino acid be at least about 0.01%, by weight. Below about 0.01%, by weight the chemical activity decreases thereby increasing the contact time required to generate a sufficient surface. It is desired to maintain low concentrations of sodium silicate and α-amino acid in the electrolyte solution to facilitate the subsequent rinsing operation. This desire is in conflict with the desire for rapid activity as would be realized to one of ordinary skill in the art. The preferred concentration of sodium silicate and α-amino acid are determined to achieve both objectives. It would be realized that operation outside of these preferred ranges is capable particularly if the necessity for either one of rinsing or chemical activity can be compromised in favor of the other. It is most preferred that the anodizing solution contain between 0.1% and 1%, by weight, sodium silicate and between 0.1% and 1%, by weight, α-amino acid. In practice, a solution with a similar amount of α-amino acid and sodium silicate has been found to provide a suitable solution at the appropriate pH. It is most preferred that the solution be maintained at a pH of no more than about 7. More preferably, the pH is maintained between about 5 and 7. Below a pH of about 5 the rate at which the aluminium is anodized decreases. It is most preferred that the anodizing solution be maintained at a pH of about 6 to about 7. At a pH of about 6-7 the solution has been demonstrated to be stable for an excess of 5 days without visibly noticeable precipitation.

Suitable α-amino acid include aspartic acid, glutamic acid, lysine, tyrosine, threonine, glycine, alanine, valine, leucine, isoleucine, methionine, proline, phenylalanine, tryptothan, serine, cysteine, asparginine, glutamine, arginine, histidine, and a-aminoadipic acid. Particularly preferred α-amino acids include aspartic acid, glutamic acid, lysine, tyrosine, threonine. More preferably the α-amino acid is aspartic acid or glutamic acid. The most preferred α-amino acid is aspartic acid.

The α-amino acid is selected, in part, based on solubility and pKa. It is most preferred that the solubility be at least 0.04 g/100 ml H₂O at 25° C. with a first dissociation constant (pK₁) of at least about 1.7 to no more than about 2.7. Below a solubility of 0.04 g/100 ml H₂O at 25° C. the chemical activity diminishes due to the limited number of molecules in solution. The first dissociation constant must be sufficient to insure that the pH is proper at reasonable concentrations of α-amino acid.

Additional adjuvants can be added to the solution if desired. Additional of α-hydroxy carboxylic acids are a particularly preferred additive. It is most preferred that no more than about 5%, by weight, α-hydroxy carboxylic acids, be included in the anodizing solution. More preferably the anodizing solution comprises no more than about 1%, by weight, α-hydroxy carboxylic acids. It is most preferred that the anodizing solution comprise about 0.5 to about 1%, by weight, α-hydroxy carboxylic acids. The amount of α-hydroxy carboxylic acid should be sufficient to maintain the pH in the preferred range. Preferred α-hydroxy carboxylic acids include malic acid, tartaric acid and citric acid. Particularly preferred is tartaric acid.

The process for manufacturing a stacked foil conductive polymer is known in the art. Specifically, stacked foil conductive polymer-containing solid capacitors may be treated with the inventive solution to produce an anodic oxide film on the edges of the coupon, repair any cracks in the anodic oxide from handling, and impart hydration resistance to the anodic oxide already present on the coupon.

The stacked foil conductive polymer-containing solid capacitors are typically prepared from anode foil coupons cut from etched and anodized foil and mounted on carrier bars, by welding or similar means, for processing.

Coupons are cut and welded to a process bar. Masking is applied to prevent wicking of the materials used to produce the conductive polymer into the weld zone of the coupons. The coupons are then heat-treated at a temperature sufficiently high to drive-off a significant amount of water of hydration in the anodic oxide (if present) but low enough to prevent decomposition of the organic masking material. The temperature of this first heat treatment is typically about 200° C. to about 380° C., more preferably about 300° C. to about 375° C. Typical times for the heat treatment are about 15 to about 30 minutes, but the actual time necessary would be determined based on the amount of treatment desired as well known within the skill of the art. In general, higher temperatures require shorter thermal exposure times

The coupons are then immersed in an anodizing electrolyte preferably of the present invention.

Voltage is applied to the coupons until the current decays to a predetermined low value typically a few microamperes or less per coupon. The applied voltage is generally equal to, or slightly less than, the voltage used to anodize the foil from which the coupons were cut. The applied voltage is typically about 65% to about 100%, preferably about 75% to about 95%, of the original anodizing voltage.

The temperature of the electrolyte is not critical, but should not vary more than about 5° C. up or down. The temperature may be about 25° C. to 90° C. Slightly higher voltages are required for lower electrolyte temperature. The coupons are then rinsed in distilled or de-ionized water to remove the anodizing solution.

The edge-anodized and rinsed coupons are then heated treated a second time for about 15 to 30 minutes. The temperature of the second heat treatment is typically from about 200° C. to about 380° C. and more preferably between about 300° C. to about 375° C. Again, the actual time need is determined based on the amount of treatment desired as known in the art. Higher temperatures require shorter thermal exposure times.

The coupons, after cooling, are then immersed in a second anodizing electrolyte. The second electrolyte is also preferably the inventive anodizing solution. The second anodizing electrolyte may be the same as the first or different. It is most preferred that the first and second anodizing electrolyte be the same. It is most preferable that the first or second electrolyte be the inventive electrolyte.

Voltage is applied to the coupons until the current decays to a predetermined value typically a few microamperes or less per coupon. The end currents obtained for this second anodizing step are generally lower than for the first edge anodizing step, described above. The voltages and temperatures employed are in the same ranges as for the first anodizing step. The anode coupons are then rinsed in distilled or deionized water to remove the anodizing solution and are then ready for further processing.

Anode coupons processed according to the invention are found to have greatly enhanced resistance to hydration compared to the prior art in addition to a chemical resistance. Obtaining both chemical and hydration resistance is not presently available in the art. The improved chemical and hydration resistance greatly enhances the resulting capacitor. By decreasing the detrimental hydrolysis or chemical degradation the resulting capacitor can be manufactured with a tighter tolerance, and therefore more predictable performance, than currently available in the art.

The temperature range employed for the heat-treatment steps is much below that of the prior art, for example, the 400° C. to 550° C. temperature range specified in U.S. Pat. No. 4,481,084. The organic masking materials, carrier bars, etc. are not adversely effected by the heating steps. Moreover, because the anode coupons are already anodized prior to the edge anodizing step, and much of the water of hydration is removed during the heat-treating steps, the anodizing solutions of the invention do not dissolve aluminium from the anode coupons at an excessive rate. This extends the useful life of the anodizing solution since aluminium concentration does not increase rapidly over time.

The present invention is superior with regards to the ability to incorporate silicon oxide, from the silicate, into the crystalline lattice of the aluminium oxide barrier layer in a controlled manner. It is most preferred that a sufficient amount of silicate be incorporated into the oxide layer to render the layer chemical resistant. It is most preferred that the oxide layer comprise 10 to 200 ppm silicon oxide. Below about 10 ppm silicon oxide the effects are diminished. Silicate addition above 200 ppm does not provide major additional benefit and may be detrimental at excessively high levels. More preferably, the oxide layer comprises about 20 ppm to about 100 ppm silicate. Even more preferably the oxide layer comprises about 50 to about 100 ppm. About 60 ppm silicate in the oxide layer has been determined to be optimum. The ability to incorporate silicates into the oxide layer at these levels, reproducibly, is currently not available in the art.

### EXAMPLES

An anodizing solution would be prepared comprising about 0.1% to about 1%, by weight sodium silicate and about 0.1% to about 1%, by weight α-amino acid and optionally about 0.1 to about 1%, by weight, α-hydroxy carboxylic acid. The solution would be stable for at least five days without cloudiness or visibly noticeable precipitation. An aluminium substrate would be anodized with the anodizing solution and an oxide layer would be formed with approximately 60 ppm silicate incorporated therein. The oxide layer would demonstrate superior hydration resistance and superior resistance to chemical contamination compared to the prior art. A series of capacitors would be prepared comprising a series of anodized substrates prepared by the anodizing solution. The resulting series of capacitors would have excellent reproducibility.

The invention has been described with particular emphasis on the preferred embodiments. It would be realized from the teachings herein that other embodiments, alterations, and configurations could be employed without departing from the scope of the invention which is more specifically set forth in the claims which are appended hereto.

1-13. (canceled)

14. A method of anodizing comprising suspending at least one aluminium substrate into an electrolytic solution and applying an anodizing current to the electrolytic solution wherein the electrolyte solution comprises 0.01-5%, by weight, sodium silicate and 0.01-5%, by weight, α-amino acid.

15. The method of anodizing of claim 14 comprising 0.1% and 1%, by weight, sodium silicate.

16. The method of anodizing of claim 14 comprising 0.1% and 1%, by weight, α-amino acid.

17. The method of anodizing of claim 14 wherein said α-amino acid comprises at least one compound selected from a group consisting of aspartic acid, glutamic acid, lysine, tyrosine, threonine, glycine, alanine, valine, leucine, isoleucine, methionine, proline, phenylalanine, tryptothan, serine, cysteine, asparginine, glutamine, arginine, histidine, and α-aminoadipic acid.

18. The method of anodizing of claim 17 wherein said α-amino acid is selected from a group consisting of aspartic acid, glutamic acid, lysine, tyrosine and threonine.

19. The method of anodizing of claim 18 wherein said α-amino acid is selected from a group consisting of aspartic acid and glutamic acid.

20. The method of anodizing of claim 19 wherein said α-amino acid is aspartic acid.

21. The method of anodizing of claim 14 wherein said α-amino acid has a solubility of at least 0.04 g/100 ml H₂O at 25° C. and a first dissociation constant (pK₁) of at least 1.7 to no more than 2.7.

22. The method of anodizing of claim 14 wherein said composition has a pH of at least about 6 to no more than about 7.

23. The method of anodizing of claim 14 further comprising an α-hydroxy carboxylic acid.

24. The method of anodizing of claim 23 wherein said α-hydroxy carboxylic acid is present at a concentration of no more than about 5%, by weight.

25. The method of anodizing of claim 23 wherein said α-hydroxy carboxylic acid is selected from a group consisting of malic acid, tartartic acid and citric acid.

26. The method of anodizing of claim 25 wherein said α-hydroxy carboxylic acid is tartartic acid.

27. A method for forming an aluminium oxide barrier layer on an aluminium substrate comprising suspending at least one aluminium substrate into an electrolytic solution and applying an anodizing current to the electrolytic solution wherein the electrolyte solution comprises 0.01-5%, by weight, sodium silicate and 0.01-5%, by weight, α-amino acid.

28. The method for forming an aluminium oxide barrier layer on an aluminium substrate of claim 27 wherein said aluminium oxide barrier layer comprises silicate.

29. The method for forming an aluminium oxide barrier layer on an aluminium substrate of claim 28 wherein said aluminium oxide barrier layer comprises about 20 ppm to about 200 ppm silicate.

30. The method for forming an aluminium oxide barrier layer on an aluminium substrate of claim 29 wherein said aluminium oxide barrier layer comprises about 50 to about 100 ppm silicate.

31. The method for forming an aluminium oxide barrier layer on an aluminium substrate of claim 30 wherein said aluminium oxide barrier layer comprises about 60 ppm silicate.

32. A capacitor comprising an aluminium substrate anodized by the method of claim 27.

33. The method for forming an aluminium oxide barrier layer on an aluminium substrate of claim 27 comprising 0.1% and 1%, by weight, sodium silicate.

34. The method for forming an aluminium oxide barrier layer on an aluminium substrate of claim 27 comprising 0.1% and 1%, by weight, α-amino acid.

35. The method for forming an aluminium oxide barrier layer on an aluminium substrate of claim 27 wherein said α-amino acid comprises at least one compound selected from a group consisting of aspartic acid, glutamic acid, lysine, tyrosine, threonine, glycine, alanine, valine, leucine, isoleucine, methionine, proline, phenylalanine, tryptothan, serine, cysteine, asparginine, glutamine, arginine, histidine, and α-aminoadipic acid.

36. The method for forming an aluminium oxide barrier layer on an aluminium substrate of claim 35 wherein said α-amino acid is selected from a group consisting of aspartic acid, glutamic acid, lysine, tyrosine and threonine.

37. The method for forming an aluminium oxide barrier layer on an aluminium substrate of claim 36 wherein said α-amino acid is selected from a group consisting of aspartic acid and glutamic acid.

38. The method for forming an aluminium oxide barrier layer on an aluminium substrate of claim 37 wherein said α-amino acid is aspartic acid.

39. The method for forming an aluminium oxide barrier layer on an aluminium substrate of claim 27 wherein said α-amino acid has a solubility of at least 0.04 g/100 ml H₂O at 25° C. and a first dissociation constant (pK₁) of at least 1.7 to no more than 2.7.

40. The method for forming an aluminium oxide barrier layer on an aluminium substrate of claim 27 wherein said composition has a pH of at least about 6 to no more than about 7.

41. The method for forming an aluminium oxide barrier layer on an aluminium substrate of claim 27 further comprising an α-hydroxy carboxylic acid.

42. The method for forming an aluminium oxide barrier layer on an aluminium substrate of claim 41 wherein said α-hydroxy carboxylic acid is present at a concentration of no more than about 5%, by weight.

43. The method for forming an aluminium oxide barrier layer on an aluminium substrate of claim 41 wherein said α-hydroxy carboxylic acid is selected from a group consisting of malic acid, tartartic acid and citric acid.

44. The method for forming an aluminium oxide barrier layer on an aluminium substrate of claim 43 wherein said α-hydroxy carboxylic acid is tartartic acid.

45. An aluminium substrate comprising an aluminium oxide barrier layer prepared by a method comprising suspending said aluminium substrate into an electrolytic solution and applying an anodizing current to the electrolytic solution wherein the electrolyte solution comprises 0.01-5%, by weight, sodium silicate and 0.01-5%, by weight, α-amino acid.

46. The aluminium substrate of claim 45 wherein said aluminium oxide barrier layer comprises silicate.

47. The aluminium substrate of claim 45 wherein said aluminium oxide barrier layer comprises about 20 ppm to about 200 ppm silicate.

48. The aluminium substrate of claim 47 wherein said aluminium oxide barrier layer comprises about 50 to about 100 ppm silicate.

49. The aluminium substrate of claim 48 wherein said aluminium oxide barrier layer comprises about 60 ppm silicate.

50. A capacitor comprising an aluminium substrate anodized by the method of claim 45.

51. The aluminium substrate of claim 45 comprising 0.1% and 1%, by weight, sodium silicate.

52. The aluminium substrate of claim 45 comprising 0.1% and 1%, by weight, α-amino acid.

53. The aluminium substrate of claim 45 wherein said α-amino acid comprises at least one compound selected from a group consisting of aspartic acid, glutamic acid, lysine, tyrosine, threonine, glycine, alanine, valine, leucine, isoleucine, methionine, proline, phenylalanine, tryptothan, serine, cysteine, asparginine, glutamine, arginine, histidine, and α-aminoadipic acid.

54. The aluminium substrate of claim 53 wherein said α-amino acid is selected from a group consisting of aspartic acid, glutamic acid, lysine, tyrosine and threonine.

55. The aluminium substrate of claim 54 wherein said α-amino acid is selected from a group consisting of aspartic acid and glutamic acid.

56. The aluminium substrate of claim 55 wherein said α-amino acid is aspartic acid.

57. The aluminium substrate of claim 45 wherein said α-amino acid has a solubility of at least 0.04 g/100 ml H₂O at 25° C. and a first dissociation constant (pK₁) of at least 1.7 to no more than 2.7.

58. The aluminium substrate of claim 45 wherein said composition has a pH of at least about 6 to no more than about 7.

59. The aluminium substrate of claim 45 further comprising an α-hydroxy carboxylic acid.

60. The aluminium substrate of claim 59 wherein said α-hydroxy carboxylic acid is present at a concentration of no more than about 5%, by weight.

61. The aluminium substrate of claim 59 wherein said α-hydroxy carboxylic acid is selected from a group consisting of malic acid, tartartic acid and citric acid.

62. The aluminium substrate of claim 61 wherein said α-hydroxy carboxylic acid is tartartic acid.

63. (canceled)
